(19) United States
(12) Patent Application Publication
(10) Pub. No.: US 2012/0324560 A1
(43) Pub. Date: Dec. 20, 2012

(54) TOKEN DATA OPERATIONS

(75) Inventors: Bryan Matthew, Bothell, WA (US); Rajeev Nagar, Sammamish, WA (US); Neal Christiansen, Bellevue, WA (US); Dustin Green, Redmond, WA (US); Jaivir Aithal, Bellevue, WA (US)

(73) Assignee: Microsoft Corporation, Redmond, WA (US)

(21) Appl. No.: 13/162,592

(22) Filed: Jun. 17, 2011

(51) Int. Cl. H04L 9/32

(52) U.S. Cl. 726/9

(57) ABSTRACT

In one embodiment, a host application may manage a data set maintained at a storage device using a token. A processor 220 of a host computer executing a host application may obtain a token representing a data set. The processor 220 may read a data set result based on the data set into a memory local to the host application. The data set result may be a data set copy, a data set digest, or a data set transformation.

### BACKGROUND

A first host computer may run a first software application, or first host application, that may share a set of data, or data set, with a second application on a second host computer, or second host application. The first host application may send that data set to the second host application. The first host application may store the data set in a data storage system accessible by the second host application. The data storage system may be a storage array attached to a storage area network (SAN). The array is a logical storage device potentially accessible from multiple geographic locations.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to managing a data set maintained at a storage device using a token. A processor of a host computer executing a host application may obtain a token representing a data set. The processor may read a data set result based on the data set into a memory local to the host application using the token. The data set result may be a data set copy, a data set digest, or an output token of a data set transformation.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a host application data storage network.

FIG. 2 illustrates, in a block diagram, one embodiment of a computing device.

FIG. 3 illustrates, in a flowchart, one embodiment of a method of sending a token from a source host application.

FIG. 4 illustrates, in a flowchart, one embodiment of a method of retrieving a data set copy with a target host application.

FIG. 5 illustrates, in a flowchart, one embodiment of a method of retrieving a data set digest with a target host application.

FIG. 6 illustrates, in a flowchart, one embodiment of a method of retrieving a data set transform with a target host application.

FIG. 7 illustrates, in a flowchart, one embodiment of a method of providing a data set copy with a data storage system.

FIG. 8 illustrates, in a flowchart, one embodiment of a method of providing a data set digest with a data storage system.

FIG. 9 illustrates, in a flowchart, one embodiment of a method of providing a data set transform with a data storage system.

FIG. 10 illustrates, in a flowchart, one embodiment of a method of performing a transformation on the data set with a data storage system.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a host application for a computing device.

A host computer executing a host application may offload data operations to a data storage system optimized for storing, transforming, digesting, and transporting large data sets. The host application may identify a data set stored on a data storage system and have that data represented by a sequence of bytes referred to as a token. The token may represent a data set without describing the physical address of the data set. Any host application may use that token to then retrieve the data set from the data storage system. As long as the host application has the token, the host application may retrieve the data set without knowing the exact physical location of the data set.

Further, any host application may use the token to read a result of the data set into a memory local to the host application. The data set result may be a data set copy, a data set digest, or an output token representing a data set transformation. The data set copy is the data stored in the data set. The data set digest is a description of the data stored in the data set. The data set transformation is a new data set produced by performing an operation on the original data set. A data manipulation agent resident in the data storage system may create a data set digest or a data set transformation.

A first host application and a second host application may run on separate host computers or the same host computer. The first host application, referred to as the source host application, may transport a data set to the second host application, referred to as the target host application using the token. The source host application may send the token to a target host application. The target host application may use the token to read the data set into a memory local to the target host application.

Thus, in one embodiment, a host application may manage a data set maintained at a storage device using a token. A processor of a host computer executing the host application may obtain a token representing a data set. The processor may use the token to read a data set result based on the data set into a memory location addressable by the host application, such as a memory local to the host application. The data set result may be a data set copy, a data set digest, or an output token of a data set transformation.

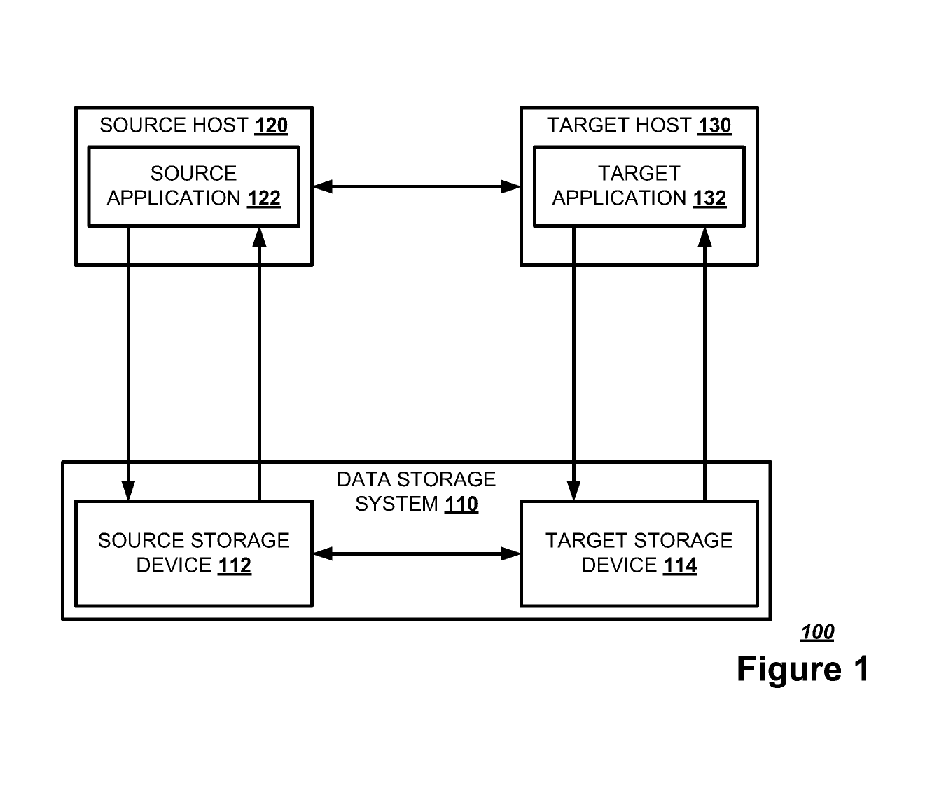

FIG. 1 illustrates, in a block diagram, one embodiment of a host application data storage network 100. A data storage system 110 is a set of one or more interconnected data storage devices accessible by one or more host applications running on one or more host computers. The data storage system 110 may be located in a single geographical location or spread over multiple geographical locations. A source data storage device 112 of the data storage system 110 may send a data set to a target data storage device 114 of the data storage system 110. A data storage device may be the source data storage device 112 in one data exchange and the target data storage device 114 in a second data exchange. The source data storage device 112 and the target data storage device 114 may be located in multiple locations, possibly over a great geographical distance.

A source host computer 120 executing a source host application 122 may send a data set to the source data storage device 112 for storage. The source data storage device 112 may create a token representing the data set. The source data storage device 112 may then return the token to the source host application 122. The source data storage device 112 may store the data set or keep the data set in memory. The source host application 122 may use that token to read the data set from the source storage device 112.

The token may remain valid as long as the data set remains unchanged. While the token remains valid according to the data storage system 110, the source host application 122 may use the token to read the data set from the source data storage system 112 into a memory local to the source host application 122. Additionally, the source host application 122 may send the token across a network to a target host computer 130 running a target host application 132. A host computer running a host application may be a source host computer 120 running a source host application 122 in one data exchange and a target host computer 130 running a target host application 132 in a second data exchange. The target host application 132 may use the token to read the data set from the target data storage system 114 into a memory local to the target host application 132. The target data storage device 114 may request the data set from the source data storage device 112 upon receipt of the token from the target host application 132. Alternately, the source host application 122 may alert the source data storage device 112 to send the data set to the target storage device 114 when the source host application 122 sends the token to the target host application 132.

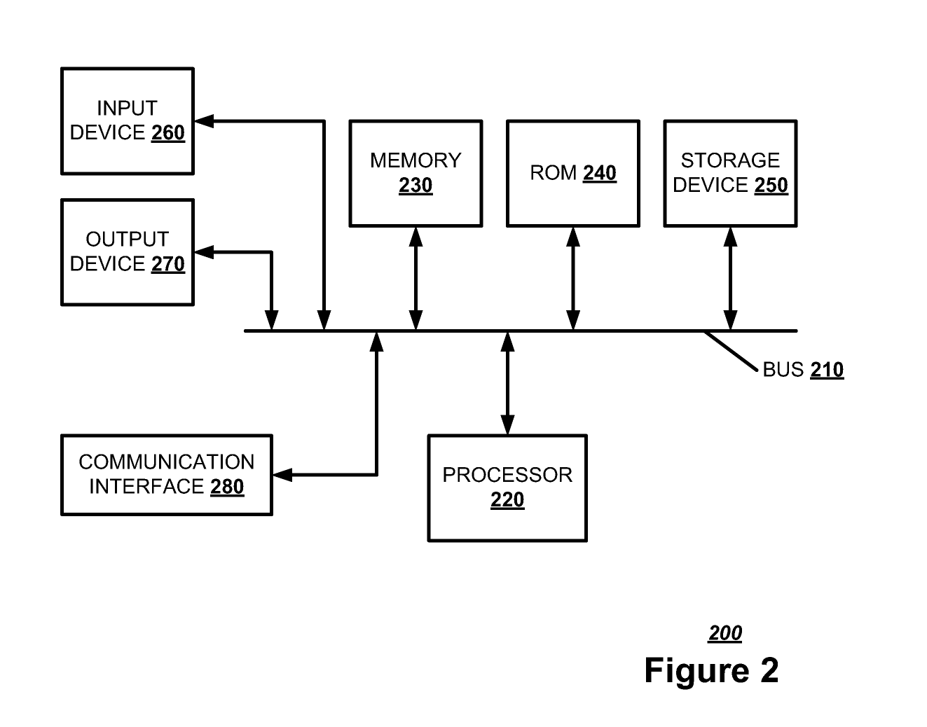

FIG. 2 illustrates a block diagram of an exemplary computing device 200 which may act as either a host computer or a data storage device. The computing device 200 may combine one or more of hardware, software, firmware, and system-on-a-chip technology to implement data management. The computing device 200 may include a bus 210, a processor 220, a memory 230, a read only memory (ROM) 240, a storage device 250, an input device 260, an output device 270, and a communication interface 280. The bus 210 may permit communication among the components of the computing device 200. The computing device 200 may also use alternative communication systems to the bus 210, such as an on chip component network.

The processor 220 may include at least one conventional processor or microprocessor that interprets and executes a set of instructions. The memory 230 may be a random access memory (RAM) or another type of dynamic storage device that stores information and instructions for execution by the processor 220. The memory 230 may also store temporary variables or other intermediate information used during execution of instructions by the processor 220. The ROM 240 may include a conventional ROM device or another type of static storage device that stores static information and instructions for the processor 220. The storage device 250 may include any type of tangible machine-readable medium, such as, for example, magnetic or optical recording media and its corresponding drive. The storage device 250 may store a set of instructions detailing a method that when executed by one or more processors cause the one or more processors to perform the method. The storage device 250 may also be a database or a database interface for interacting with the data storage system.

The input device 260 may include one or more conventional mechanisms that permit a user to input information to the computing device 200, such as a keyboard, a mouse, a voice recognition device, a microphone, a headset, etc. The output device 270 may include one or more conventional mechanisms that output information to the user, including a display, a printer, one or more speakers, a headset, or a medium, such as a memory, or a magnetic or optical disk and a corresponding disk drive. The communication interface 280 may include any transceiver-like mechanism that enables processing device 200 to communicate with other devices or networks. The communication interface 280 may include a network interface or a mobile transceiver interface. The communication interface 280 may be a wireless, wired, or optical interface. The communication interface 280 may connect the computing device 200 to a data storage system 110 or a host computer.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the storage device 250, or from a separate device via the communication interface 280.

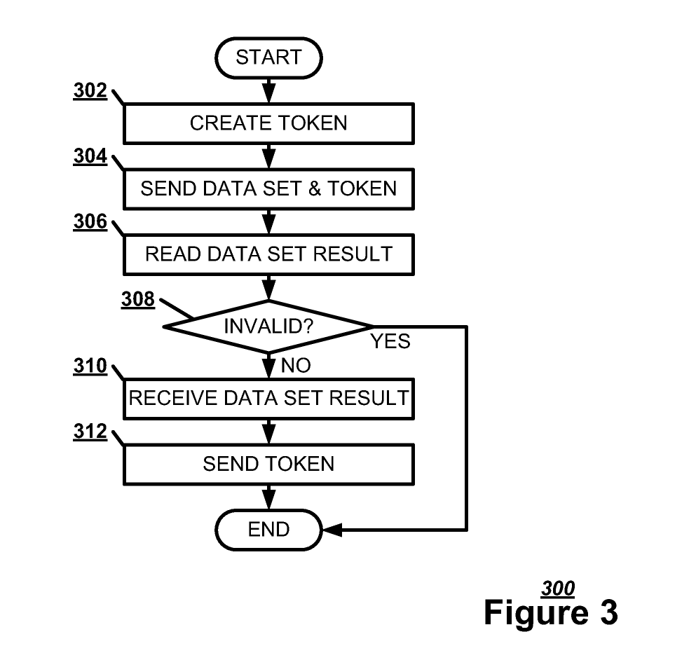

FIG. 3 illustrates, in a flowchart, one embodiment of a method 300 of sending a token from a source host application 122. The source host application 122 may create a token associated with a data set (Block 302). The data set may be unchanged while represented by the token. The source host application 122 may send the data set and the token to a data storage system 110 (Block 304). Alternately, the source host application 122 may send the data set to the data storage system 110 and receiving the token from data storage system 110. Further, the source host application 122 may request a token from a data storage system 110 for a data set previously stored on the data storage system 110. The source host application 122 may use the token to execute a read of a data set result based on the data set into a memory location addressable by the host application, such as a memory local to the source host application 122 (Block 306). The data set result may be a data set copy, a data set digest, or an output token of a data set transformation. The data set copy is a copy of the data set. The data set digest is a condensed set of data describing the data stored in the data set. The data set transformation is a set of data created using the unchanged set of data represented by the token.

If the source host application 122 discovers in executing the read that the token is invalidated by a change in the data set (Block 308), the source host application 122 may be unable to retrieve the data set result. Otherwise, the source host application 122 may receive the data set result from the data storage device (Block 310). The source host application may send the token to a target host application (Block 312).

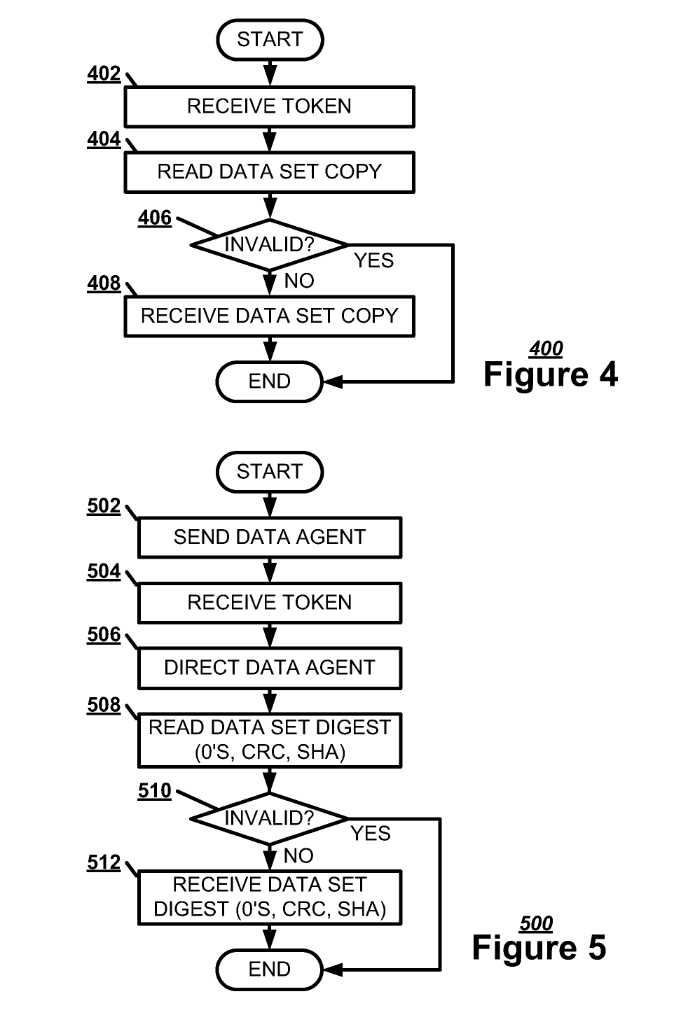

FIG. 4 illustrates, in a flowchart, one embodiment of a method 400 of retrieving a data set copy with a target host application 132. The target host application 132 may receive a token representing a data set from a token source (Block 402). The token source may be a data storage system 110 or a source host application 122. The target host application 132 may use the token to execute a read of a data set copy based on the data set into a memory local to the target host application 132 (Block 404). If the target host application 132 discovers in executing the read that the token is invalidated by a change in the data set (Block 406), the target host application 132 may be unable to retrieve the data set copy. Otherwise, the target host application 132 may receive the data set copy from the data storage device (Block 408).

FIG. 5 illustrates, in a flowchart, one embodiment of a method 500 of retrieving a data set digest with a target host application 132. The target host application 132 may send a data manipulation agent to the target data storage device 114 to create a data set digest (Block 502). A data manipulation agent is a set of code that is operated at the data storage device that performs calculations or transformations of a data set stored on that data storage device before passing the data set to other devices. The target host application 132 may receive a token representing a data set from a token source (Block 504). As stated, the token source may be a data storage system 110 or a source host application 122. The target host application 132 may direct the target data storage device 114 to execute the data manipulation agent to create a data set digest from the data set (Block 506). The target host application 132 may use the token to execute a read of the data set digest based on the data set into a memory local to the target host application 132 (Block 508). If the target host application 132 discovers in executing the read that the token is invalidated by a change in the data set (Block 510), the target host application 132 may be unable to retrieve the data set digest. Otherwise, the target host application 132 may receive the data set digest from the data storage device (Block 512).

The data set digest may be a logical zero check, a cyclical redundancy check, or a cryptographic hash message. A logical zero check determines if the data set is logically equivalent to zero or is an empty data set. A cyclical redundancy check is an error checking code that creates a check value by performing a calculation on the data in a data set. The check value may be appended to a data transmission, with the receiver comparing the check value to a fresh calculation performed on the data set. A cryptographic hash message is a fixed size bit string, or hash value, produced by a secure hash algorithm executed on the data set. If the data set is changed, the hash value reflects that change.

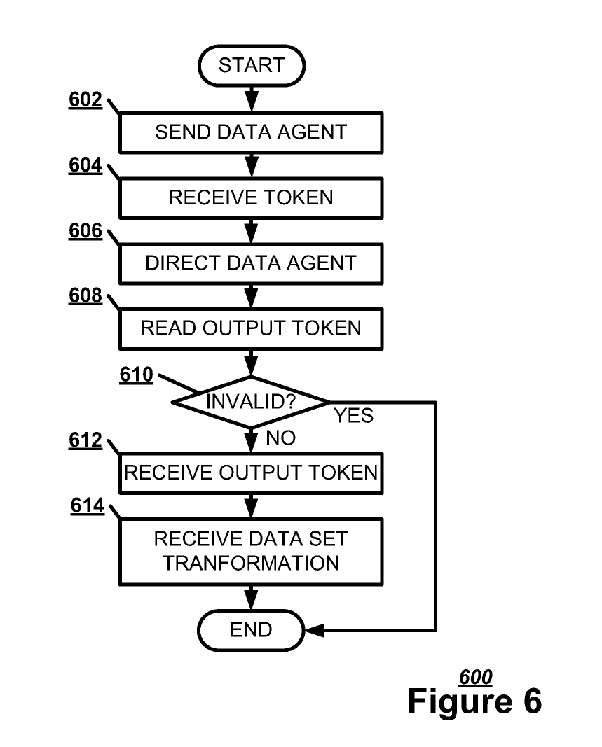

FIG. 6 illustrates, in a flowchart, one embodiment of a method 600 of retrieving a data set transform with a target host application 132. The target host application 132 may send a data manipulation agent to the target data storage device 114 to create a data set transformation (Block 602). The target host application 132 may receive a token representing a data set from a token source (Block 604). The target host application 132 may direct the target data storage device 114 to execute the data manipulation agent to perform a transformation on the data set (Block 606). The target host application 132 may use the token to execute a read of an output token representing a data set transformation into a memory local to the target host application 132 (Block 608). If the target host application 132 discovers in executing the read that the token is invalidated by a change in the data set (Block 610), the target host application 132 may be unable to retrieve an output token representing the data set transformation. Otherwise, the target host application 132 may receive the output token representing a data set transformation from the target data storage device 114 (Block 612). The target host application 132 may use the output token to read the data set transformation into a memory local to the target host application 132 (Block 614).

The data set transformation may be a compression, a decompression, a concatenation, or other calculation on or transformation to the data set. A compression creates a data representation of the data set using fewer data resources by sacrificing some of the functionality of the data set, possibly for storage or transmission of the original data set. A decompression creates a data representation of the data set using more data resources to increase the functionality of the data set. A concatenation combines the data set with an additional data set.

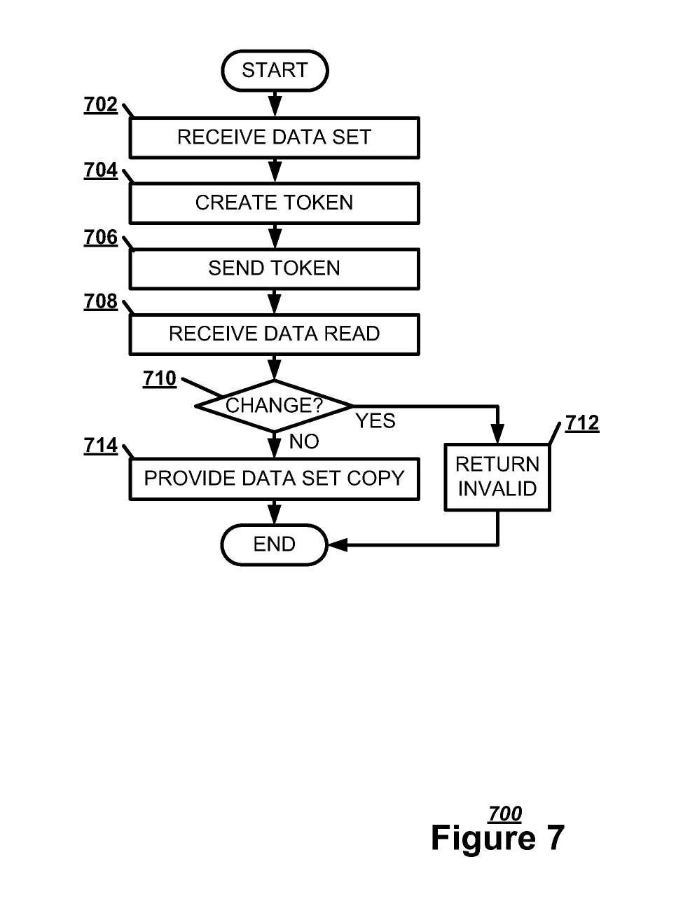

FIG. 7 illustrates, in a flowchart, one embodiment of a method 700 of providing a data set copy with a data storage system 110. The data storage device may receive a data set from a data set source (Block 702). The data set source may be a source data storage device 112, a source host application 122, or other source providing a data set. The data storage device may create the token (Block 704). The data storage device may send the token to the host application (Block 706). Alternately, the data storage device may receive a token created by the source host application.

The data storage device may receive a data read request from a host application (Block 708). The host application may be a source host application 122 or a target host application 132. If the data set has changed, rendering the token invalid (Block 710), the data storage device may return an invalidity message to the host application indicating a change to the data set (Block 712). Otherwise, the data storage device may provide a data set copy based on the data set to a memory local to the host application (Block 714).

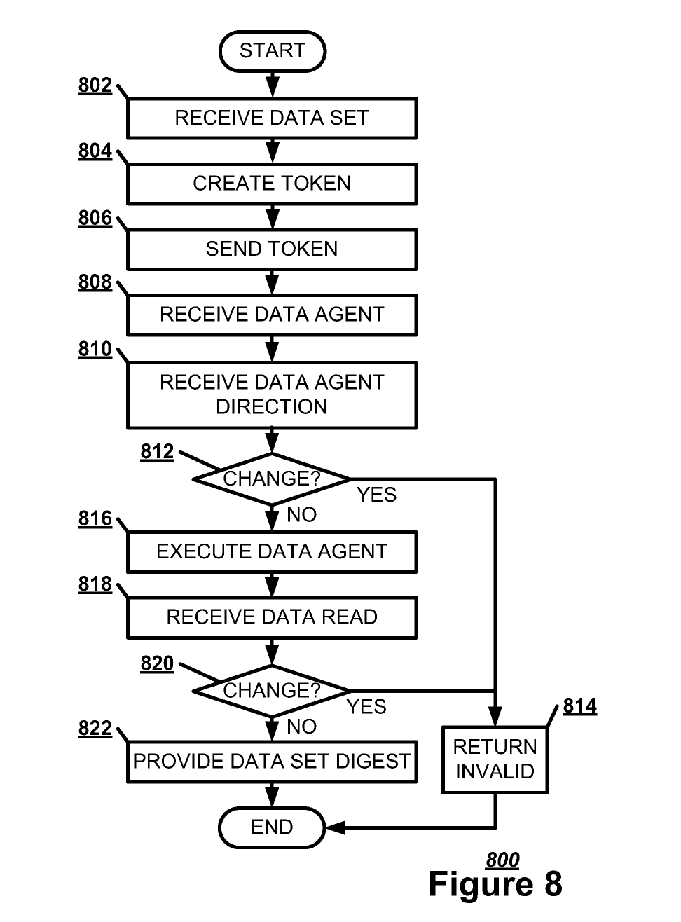

FIG. 8 illustrates, in a flowchart, one embodiment of a method 800 of providing a data set digest with a data storage system 110. The data storage device may receive a data set from a data set source (Block 802). The data storage device may create the token (Block 804). The data storage device may send the token to the host application (Block 806). Alternately, the data storage device may receive a token created by a source host application. The data storage device may receive a data manipulation agent from a host application (Block 808). The host application may be a source host application 122 or a target host application 132.

The data storage device may receive a direction from the host application to execute the data manipulation agent to create a digest based on the data set (Block 810). If the data set has changed, rendering the token invalid (Block 812), the data storage device may return an invalidity message to the host application indicating a change to the data set (Block 814). The data storage device may execute the data manipulation agent to create a digest of the data set (Block 816). The data storage device may receive a data read request from the host application (Block 818). If the data set has changed, rendering the token invalid (Block 820), the data storage device may return an invalidity message to the host application indicating a change to the data set (Block 814). Otherwise, the data storage device may provide a data set digest based on the data set to a memory local to the host application (Block 822).

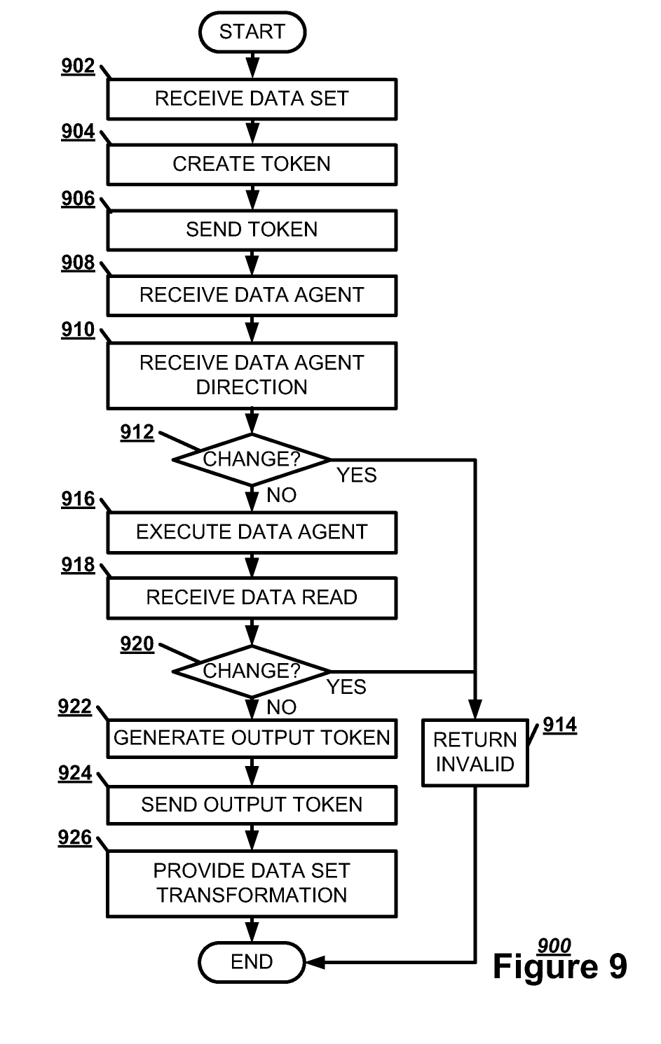

FIG. 9 illustrates, in a flowchart, one embodiment of a method 900 of providing a data set transformation with a data storage system 110. The data storage device may receive a data set from a data set source (Block 902). The data storage device may create the token (Block 904). The data storage device may send the token to the host application (Block 906). Alternately, the data storage device may receive a token created by a source host application. The data storage device may receive a data manipulation agent from a host application (Block 908).

The data storage device may receive a direction from the host application to execute the data manipulation agent to perform a transformation on the data set (Block 910). If the data set has changed, rendering the token invalid (Block 912), the data storage device may return an invalidity message to the host application indicating a change to the data set (Block 914). The data storage device may execute the data manipulation agent to perform a transformation on the data set (Block 916). The data storage device may receive a data read request from the host application (Block 918). If the data set has changed, rendering the token invalid (Block 920), the data storage device may return an invalidity message to the host application indicating a change to the data set (Block 914). Otherwise, the data storage device may generate an output token representing the data set transformation (Block 922). The data storage device may provide the output token to the host application to a memory local to the host application using the token (Block 924). The data storage device may provide a data set transformation based on the data set to a memory local to the host application in response to the use of the output token by the host application (Block 926).

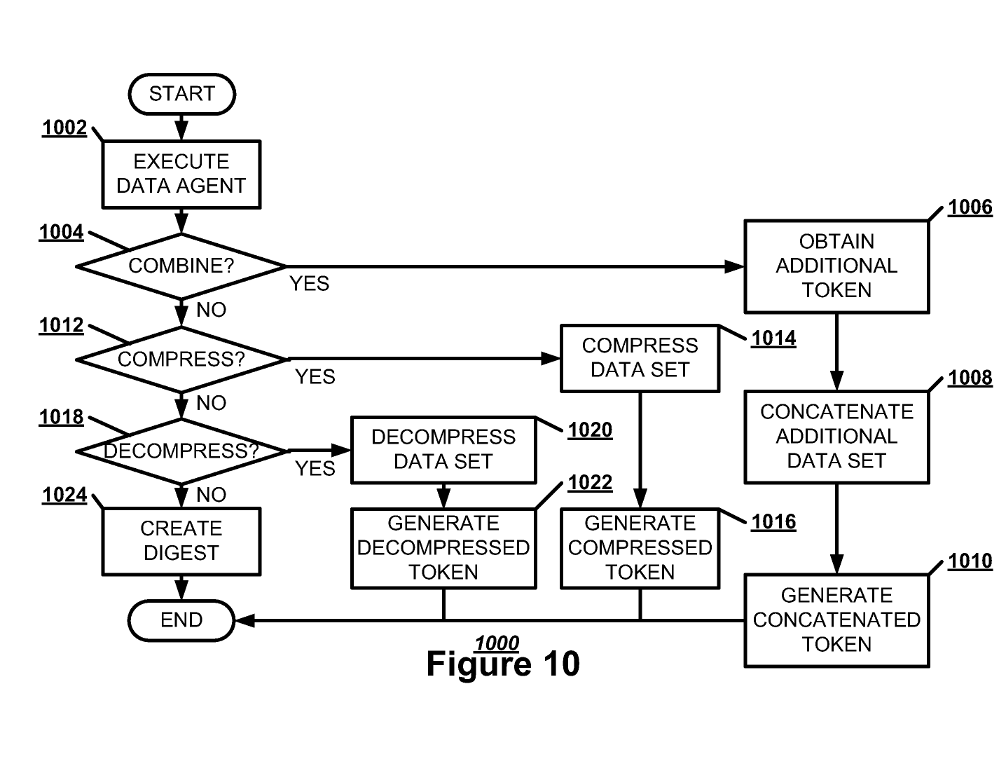

The data storage device may execute a number of data manipulation agents that each perform a different transformation on the data set, including creating a data set digest. FIG. 10 illustrates, in a flowchart, one embodiment of a method 1000 of performing a transformation on the data set with a data storage system 110 executing a data manipulation agent. The data storage device may execute a data manipulation agent to perform a transformation on the data set (Block 1002). If the data manipulation agent performs a combination action on the data set with an additional data set (Block 1004), the data storage device may obtain an additional token representing the additional data set (Block 1006). The data storage device may concatenate the additional data set to the data set (Block 1008). The data storage device may generate a concatenated token as the output token representing the data set and the additional data set (Block 1010).

If the data manipulation agent performs a compression operation on the data set (Block 1012), the data storage device may compress the data set to create a compressed version (Block 1014). The data storage device may generate a compressed token as the output token representing the compressed version of the data set (Block 1016).

If the data manipulation agent performs a decompression operation on the data set (Block 1018), the data storage device may decompress the data set to create a decompressed version (Block 1020). The data storage device may generate a decompressed token as the output token representing the decompressed version of the data set (Block 1022).

Otherwise, the data storage device may perform other transformations, such as creating a data set digest based on the data set (Block 1024). The data set digest may be a logical zero check, a cyclical redundancy check, or a cryptographic hash message.

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include non-transitory computer-readable storage media for carrying or having computer-executable instructions or data structures stored thereon. Such non-transitory computer-readable storage media may be any available media that can be accessed by a general purpose or special purpose computer. By way of example, and not limitation, such non-transitory computer-readable storage media can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A machine-implemented method for processing a data set, comprising:
obtaining in a host application a token representing the data set; and
using the token to execute a read of a data set result based on the data set into a memory location addressable by the host application.

2. The method of claim 1, wherein the data set result is at least one of a data set copy, a data set digest and an output token of a data set transformation.

3. The method of claim 1, further comprising:
creating the token in the host application; and
sending the token to the data storage system.

4. The method of claim 1, further comprising:
sending a data manipulation agent to a data storage system; and
directing the data storage system to execute the data manipulation agent to perform a transformation on the data set.

5. The method of claim 1, further comprising:
receiving the token from a token source.

6. The method of claim 1, wherein the token source is at least one of a data storage system and a source host application.

7. The method of claim 1, further comprising: sending the token to a target host application.

8. The method of claim 1, further comprising:
sending the data set to a data storage system.

9. The method of claim 1, wherein a token is invalidated by a change to the data set.

10. A tangible machine-readable medium having a set of instructions detailing a method stored thereon that when executed by one or more processors cause the one or more processors to perform the method, the method comprising:
obtaining the token representing a data set; and
providing an output token of a data set transformation based on the data set to a memory local to the host application using the token.

11. The tangible machine-readable medium of claim 10, wherein the method further comprises:
creating the token in a data storage device.

12. The tangible machine-readable medium of claim 10, wherein the method further comprises:
executing a data manipulation agent to perform a transformation on the data set.

13. The tangible machine-readable medium of claim 12, wherein the method further comprises:
receiving the data manipulation agent from a host application.

14. The tangible machine-readable medium of claim 10, wherein the method further comprises:
receiving the token from a source host application.

15. The tangible machine-readable medium of claim 10, wherein the method further comprises:
generating a compressed token as the output token representing a compressed version of the data set.

16. The tangible machine-readable medium of claim 10, wherein the method further comprises:
generating a decompressed token as the output token representing a decompressed version of the data set.

17. The tangible machine-readable medium of claim 10, wherein the method further comprises:
obtaining an additional token representing an additional data set;
generating a concatenated token as the output token representing the data set and the additional data set.

18. A computer host executing a host application, comprising:
a communication interface to receive a token representing a data set; and
a processor to use the token to execute a read of a data set digest based on the data set into a memory local to the host application.

19. The computer host of claim 18, wherein the dataset digest is at least one of a logical zero check, a cyclical redundancy check, or a cryptographic hash message.

20. The computer host of claim 18, wherein the communication interface receives the token from at least one of a data storage system and a source host application.
